(19) United States
(12) Patent Application Publication
(10) Pub. No.: US 2024/0266497 A1
(43) Pub. Date: Aug. 8, 2024

(54) POSITIVE ELECTRODE FOR SECONDARY BATTERY

(71) Applicant: HONDA MOTOR CO., LTD., Tokyo (JP)

(72) Inventors: Masanari HIGUCHI, Saitama (JP); Masahiro OHTA, Saitama (JP)

(21) Appl. No.: 18/429,441

(22) Filed: Feb. 1, 2024

(30) Foreign Application Priority Data
Feb. 3, 2023 (JP) 2023-015224

(51) Int. Cl. H01M 4/13; H01M 4/02; H01M 4/36; H01M 4/62; H01M 10/0585

(52) U.S. Cl. CPC H01M 4/13; H01M 4/366; H01M 4/62; H01M 10/0585; H01M 2004/028; H01M 2300/0065

(57) ABSTRACT

A positive electrode for a secondary battery capable of improving lithium ion conductivity and bonding strength with a solid electrolyte layer. The positive electrode for a secondary battery, includes a positive electrode current collector and a positive electrode active material layer. The positive electrode active material layer includes a positive electrode active material. The positive electrode active material is in contact with a solid electrolyte having a median diameter of 150 nm or less.

This application is based on and claims the benefit of priority from Japanese Patent Application No. 2023-015224, filed on 3 Feb. 2023, the content of which is incorporated herein by reference.

### BACKGROUND OF THE INVENTION

### Field of the Invention

The present invention relates to a positive electrode for a secondary battery.

### Related Art

In recent years, research and development have been conducted on secondary batteries that contribute to energy efficiency in order to ensure that more people have access to affordable, reliable, sustainable, and advanced energy.

Examples of such a secondary battery include a liquid battery in which an electrolytic solution and a separator are disposed between a positive electrode and a negative electrode, and a solid-state battery including a solid electrolyte instead of an electrolytic solution. Solid-state batteries are attracting attention because the batteries are excellent in that safety is improved because the solid electrolyte is non-flammable and that they have higher energy density.

As a technique relating to a solid-state battery, for example, there has been proposed an invention relating to an electrochemical cell including a multi-layer structure in contact with a surface layer of a negative electrode layer in which the multi-layer structure includes a lithium ion conducting polymer layer, with an object of having long cycle life, high lithium cycling efficiency, and high energy density and allowing cells to be more easily fabricated (see Patent Document 1).

Patent Document 1: Japanese Patent No. 5112584

### SUMMARY OF THE INVENTION

The technique disclosed in Patent Document 1 improves functions such as the lithium ion conductivity of the negative electrode layer containing metallic lithium. On the other hand, it is desired to improve the lithium ion conductivity of a positive electrode layer and the bonding strength with a solid electrolyte layer. However, since the interface between the positive electrode layer and the solid electrolyte layer in a solid-state battery is in a solid contact, there is a trade-off between improving lithium ion conductivity and bonding strength and preventing alteration of the material and breakage of the current collecting foil due to hot rolling to improve the solid contact, as well as preventing breakage of the base material due to stress relaxation. This is a bottleneck in improving performance.

In response to the above issue, it is an object of the present invention to provide a positive electrode for a secondary battery capable of improving lithium ion conductivity and bonding strength with a solid electrolyte layer.
(1) A first aspect of the present invention relates to a positive electrode for a secondary battery. The positive electrode for a secondary battery includes a positive electrode current collector and a positive electrode active material layer. The positive electrode active material layer includes a positive electrode active material. The positive electrode active material is in contact with a solid electrolyte having a median diameter of 150 nm or less.

According to the first aspect of the invention, it is possible to provide a positive electrode for a secondary battery capable of improving lithium ion conductivity and bonding strength with a solid electrolyte layer.
(2) In a second aspect of the invention according to the first aspect, the positive electrode for a secondary battery further includes an adhesive layer formed on at least one of laminated surfaces of the positive electrode active material layer. The adhesive layer includes the solid electrolyte having the median diameter of 150 nm or less as a main component.

According to the second aspect of the invention, it is possible to easily realize a positive electrode for a secondary battery capable of improving lithium ion conductivity and bonding strength with a solid electrolyte layer.
(3) In a third aspect of the invention according to the first or second aspect, a content of the solid electrolyte having the median diameter of 150 nm or less is greater toward a laminated surface where a solid electrolyte layer is laminated in a thickness direction of the positive electrode for a secondary battery.

According to the third aspect of the invention, it is possible to provide a positive electrode for a secondary battery capable of further preferably improving lithium ion conductivity and bonding strength with a solid electrolyte layer.

### BRIEF DESCRIPTION OF THE DRAWINGS

FIG. 1 is a sectional view showing an electrode laminate including a positive electrode for a secondary battery according to an embodiment of the present invention;

FIG. 2 is a graph showing the median diameter of solid electrolyte particles contained in a positive electrode for a secondary battery of the present invention; and

FIG. 3 is a graph showing the median diameter of solid electrolyte particles contained in a positive electrode for a secondary battery of the present invention.

### DETAILED DESCRIPTION OF THE INVENTION

### Secondary Battery

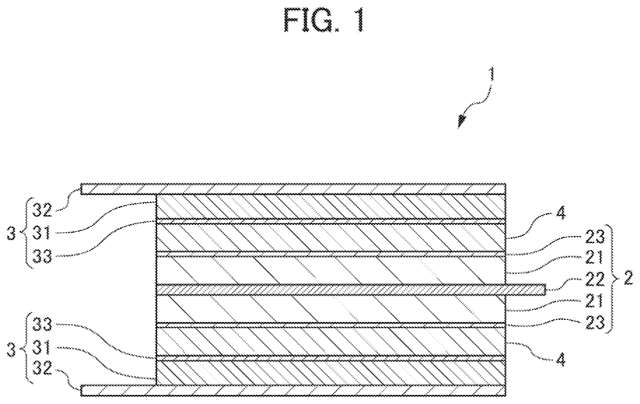

A secondary battery including a positive electrode for a secondary battery according to an embodiment of the present invention is a solid-state secondary battery including a solid electrolyte. The solid-state secondary battery includes an electrode laminate 1 shown in FIG. 1. As shown in FIG. 1, the electrode laminate 1 includes a positive electrode 2, which is a positive electrode for a secondary battery, negative electrodes 3, and solid electrolyte layers 4 each laminated between the positive electrode 2 and each of the negative electrodes 3. The electrode laminate 1 is housed in an exterior body such as a laminate film and can be used in this state.

FIG. 1 shows a configuration in which two solid electrolyte layers 4 are respectively laminated with both surfaces of one positive electrode 2, and further, negative electrodes 3 are respectively laminated with the outer surfaces of the two solid electrolyte layers 4. On the other hand, the configuration of the electrode laminate including the positive electrode 2 for a secondary battery of the present invention is not limited to the above. The number of laminated layers for each of the positive electrode, the negative electrode, and the solid electrolyte layer is not limited as long as the positive electrode and the negative electrode are laminated via the solid electrolyte layer.

### Positive Electrode

As shown in FIG. 1, the positive electrode 2 according to the present embodiment includes positive electrode active material layers 21, a positive electrode current collector 22, and adhesive layers 23. In the present embodiment, the positive electrode active material layers 21 are respectively laminated with both surfaces of the positive electrode current collector 22, and the adhesive layers 23 are respectively laminated with the outer surfaces of the positive electrode active material layers 21.

The positive electrode active material layer 21 essentially includes a positive electrode active material. The positive electrode active material is not limited, and can include any known material as a positive electrode active material for solid-state secondary batteries. Examples of the positive electrode active material include ternary positive electrode materials such as LiCoO₂, LiNiO₂, and NCM (Li(NiₓCo_{y}Mn_{z})O₂ , (0<x<1, 0<y<1, 0<z<1, x+y+z=1)), layered positive electrode active material particles such as LiVO₂ and LiCrO₂, spinel positive electrode active materials such as LiMn₂O₄, Li(Ni_{0.25}Mn_{0.75})₂O₄, LiCoMnO₄, and Li₂NiMn₃O₈, and olivine positive electrode active materials such as LiCoPO₄, LiMnPO₄, and LiFePO₄.

In addition to the positive electrode active material, the positive electrode active material layer 21 may further include a solid electrolyte, a conductivity aid, a binder, and the like. The solid electrolyte, the conductivity aid, the binder, and the like are not limited, and any known materials as electrode materials for solid-state secondary batteries can be applied. The positive electrode active material layer 21 may include a solid electrolyte having a median diameter of 150 nm or less, which will be described later. The solid electrolyte preferably has a median diameter of 100 nm.

The positive electrode current collector 22 is not limited, and any known material as a positive electrode current collector for solid-state secondary batteries can be used. Examples of the positive electrode current collector 22 include metal foils such as stainless steel (SUS) foil and aluminum (Al) foil.

The adhesive layer 23 is provided to improve the bonding strength between the positive electrode active material layer 21 and the solid electrolyte layer 4 and lithium ion conductivity, and preferably includes a solid electrolyte having a median diameter (D50) of 150 nm or less (hereinafter also referred to as “nanoscale SE”) as a main component. The solid electrolyte included in the adhesive layer 23 preferably has a median diameter of 100 nm or less. Specifically, the content of the nanoscale SE in the adhesive layer 23 is more preferably 50% by mass or more, still more preferably 90% by mass or more, and most preferably 100% by mass. The adhesive layer 23 may include other materials such as a binder to the extent that the effects of the present invention are not impaired.

The adhesive layer 23 is preferably formed on at least one of the laminated surfaces of the positive electrode active material layer 21. As a specific aspect, the adhesive layer 23 is preferably formed between the positive electrode active material layer 21 and the solid electrolyte layer 4.

By including the nanoscale SE in the adhesive layer 23, the area of contact between the positive electrode active material and the nanoscale SE at the interface between the positive electrode active material layer 21 and the adhesive layer 23 can be made larger than that in the case of using a solid electrolyte having a normal particle diameter. Thereby, the bonding strength between the positive electrode 2 and the solid electrolyte layer 4 and lithium ion conductivity can be improved. Ion paths are also relatively stable. This is because unevenness is formed on the surface of the positive electrode active material particles, and the nanoscale SE is disposed in the unevenness. It is considered that this makes it difficult to cause peeling of contact interface with the nanoscale SE due to expansion and contraction of the active material.

By providing the adhesive layers 23 to form the positive electrode 2, deformation of the electrode laminate 1 can be reduced. This is because when the positive electrode 2, the negative electrodes 3, and the solid electrolyte layers 4 are pressurized and integrated, the large compressive deformation of the adhesive layer 23 allows the deformation of the positive electrode 2, the negative electrodes 3, and the solid electrolyte layers 4 to be reduced. Therefore, it is possible to form the electrode laminate 1 including the positive electrode active material layers 21, the negative electrode active material layers 31, and the solid electrolyte layers 4, which are densified and have small compressive deformation. In addition, it is possible to increase the laminating area of the electrode laminate 1.

In the aspect shown in FIG. 1, the positive electrode 2 includes the adhesive layers 23 separately from the positive electrode active material layers 21, but the present invention is not limited to the above aspect. That is, the positive electrode 2 may not include the adhesive layers 23, or the positive electrode active material layer 21 and the adhesive layer 23 may be integrated to such an extent that they cannot be distinguished from each other as separate layers. In this case, the content of the nanoscale SE is preferably increased toward the laminated surface where the solid electrolyte layer 4 is laminated in the thickness direction of the positive electrode 2. This is because the bonding strength in the positive electrode 2 can be improved while the increase in the resistance of the ion conduction due to the grain boundary of the solid electrolyte in the positive electrode 2 is reduced, as compared with the case where the nanoscale SE is uniformly dispersed in the positive electrode 2. As a result, preferable bonding strength between the positive electrode 2 and the solid electrolyte layer 4 and preferable lithium ion conductivity can be obtained.

### Negative Electrode

The negative electrode 3 includes a negative electrode active material layer 31 and a negative electrode current collector 32. In the present embodiment, as shown in FIG. 1, the negative electrode active material layer 31 is laminated so as to be in contact with the solid electrolyte layer 4, and the negative electrode current collector 32 forms the outermost layer of the electrode laminate 1.

The negative electrode active material layer 31 essentially includes a negative electrode active material. The negative electrode active material is not limited, and any known material as a negative electrode active material for solid-state secondary batteries can be used. Examples of the negative electrode active material include lithium transition metal oxides such as lithium titanate (Li₄Ti₅O₁₂), transition metal oxides such as TiO₂, Nb₂O₃, and WO₃, metal sulfides, metal nitrides, carbon materials such as graphite, soft carbon, and hard carbon, silicon-based materials such as simple silicon, silicon alloys, and silicon compounds, as well as lithium metal, lithium alloys, and metallic indium.

In addition to the negative electrode active material, the negative electrode active material layer 31 may further include a solid electrolyte, a conductivity aid, a binder, and the like. The solid electrolyte, the conductivity aid, the binder, and the like are not limited, and any known materials as electrode materials for solid-state secondary batteries can be applied.

The negative electrode current collector 32 is not limited, and any known material as a negative electrode current collector for solid-state secondary batteries can be used. Examples of the negative electrode current collector include metal foils such as copper (Cu) foil, stainless steel (SUS) foil, and aluminum (Al) foil.

### Solid Electrolyte Layer

The solid electrolyte layer 4 essentially includes a solid electrolyte. The solid electrolyte layer 4 may include a binder and the like in addition to the above. In the present embodiment, the solid electrolyte layer 4 is laminated between the positive electrode 2 and the negative electrode 3.

Examples of the solid electrolyte include, but are not limited to, sulfide-based solid electrolytes, oxide-based solid electrolytes, nitride-based solid electrolytes, halide-based solid electrolytes, and the like.

Examples of the binder include, but are not limited to, polyvinylidene fluoride (PVdF), polymethyl methacrylate (PMMA), polyisobutene (PIB), styrene-butadiene rubber (SBR), polyethylene-vinyl acetate copolymer (PEVA), nitrile rubber (NBR), and hydrogenated nitrile rubber (HNBR). These may be used alone or in combination of two or more.

By using the positive electrode 2 according to the present embodiment, as described above, preferable bonding strength between the positive electrode 2 and the solid electrolyte layer 4 and preferable lithium ion conductivity can be obtained, so that the resistance at the interface between the positive electrode and the solid electrolyte layer decreases, and the battery capacity and durability are improved. Furthermore, in the manufacturing process of the electrode laminate 1, when each layer is rolled by a roll press method or the like, the temperature can be reduced, so that the manufacturing process can be simplified and the manufacturing cost can be reduced.

### Method for Manufacturing Solid-State Battery

The method for manufacturing a solid-state battery according to the present embodiment includes steps of forming the positive electrode 2, the negative electrodes 3, and the solid electrolyte layers 4, and a step of integrating these layers.

The step of forming the positive electrode 2 includes, for example, a step of preparing an electrode material mixture slurry containing a positive electrode active material, coating the slurry on the positive electrode current collector 22 to form the positive electrode active material layer 21. When the positive electrode 2 includes the adhesive layer 23, a step of coating a slurry containing the nanoscale SE on the formed positive electrode active material layer 21 may be included.

Examples of a method of segregating the nanoscale SE in the adhesive layer 23 include a method of using two or more solvents in the adhesive layer 23 and a method of multistage drying the adhesive layer 23. For the former method, two or more solvents having different solvencies with respect to the solid electrolyte layer are used. Thereby, since the solvent having a high solvency penetrates into the solid electrolyte layer, a concentration distribution of the nanoscale SE in the adhesive layer results. For the latter method, the nanoscale SE can be segregated by a multistage drying step in which gentle drying conditions and rapid drying conditions are combined in the drying step after the adhesive is applied. This is because the concentration distribution of the nanoscale SE occurs due to volatilization of the solvent in the surface layer of the adhesive layer under the gentle drying conditions.

The step of forming the negative electrode 3 is not limited, and includes, for example, a step of preparing an electrode material mixture slurry and coating the slurry on the negative electrode current collector 32 to form the negative electrode active material layer 31. In addition to the above, when a metal foil such as a lithium metal or a lithium alloy is used as the negative electrode active material layer, a step of bonding the negative electrode current collector 32 and the metal foil with a cladding material or the like may be included.

The step of forming the solid electrolyte layer 4 is not limited, but may include, for example, a step of preparing a solid electrolyte slurry containing a solid electrolyte and coating the solid electrolyte slurry on the formed positive electrode 2 or negative electrode 3. Alternatively, instead of the above step, a step of forming an independent sheet-shaped solid electrolyte layer 4 may be included.

The step of integrating the positive electrode 2, the negative electrode 3, and the solid electrolyte layer 4 is not limited, and may include a step of pressurizing and integrating these layers by a known uniaxial press, roll press, or the like. The step of pressurizing and integrating the layers may be a step of heating the layers simultaneously with the pressurizing. When using the positive electrode 2 according to the present embodiment, it is possible to lower the temperature (press temperature) and reduce the press pressure in the pressurizing and integrating step. For example, conventionally, the press pressure is 1000 MPa and the press temperature is 140° C. or higher, but, with the present invention, it is possible to set the press pressure to 500 MPa and the press temperature to 80° C. to 90° C. Thereby, it is possible to suppress alteration of the material due to heat, breakage of the current collecting foil due to rolling, breakage of the base material due to stress relaxation, and the like.

### Method of Preparing Nanoscale SE

A method of preparing the nanoscale SE included in the positive electrode 2 will be described below. The method of preparing the nanoscale SE includes, for example, a step of pulverizing and dispersing a solid electrolyte to which a solvent and a dispersant are added.

The solvent can be selected in consideration of reactivity with the solid electrolyte, drying conditions, and the like, and for example, toluene or the like can be used. The dispersant can be selected in consideration of solubility in a solvent and influence on ion conductivity, and for example, a polyhydric alcohol-based dispersant or the like can be used.

In the step of pulverizing and dispersing the solid electrolyte, for example, a bead mill, a jet mill, or the like can be used.

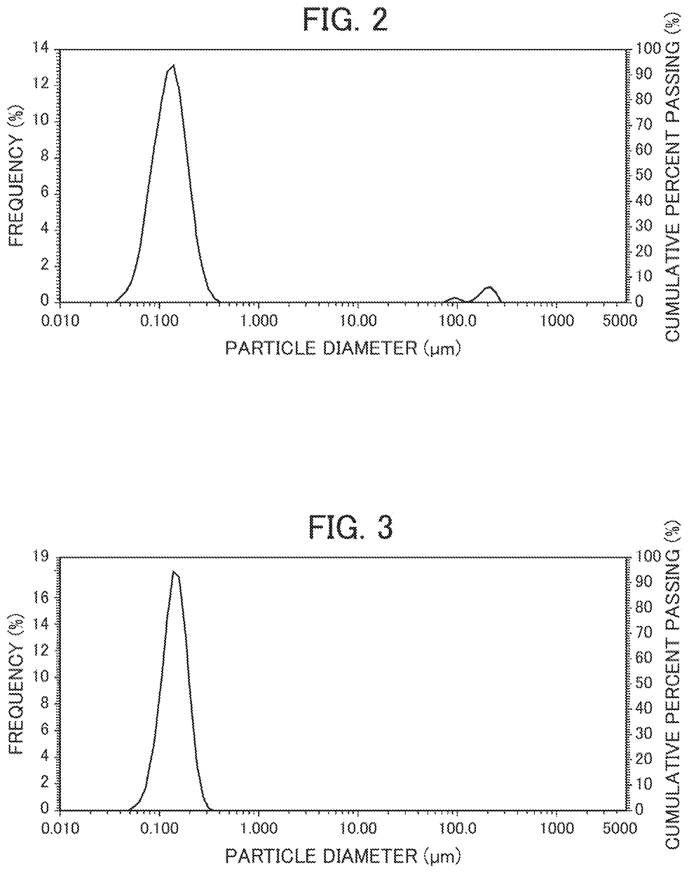

FIG. 2 is a graph showing a particle diameter distribution of solid electrolyte particles when a solid electrolyte is pulverized and dispersed using a bead mill. In the graph of FIG. 2, the horizontal axis represents the particle diameter (μm), the left vertical axis represents the frequency (%), and the right vertical axis represents the cumulative percent passing (%). The median diameter of the solid electrolyte particles in the graph of FIG. 2 is 131 nm.

FIG. 3 is a graph showing a particle diameter distribution of solid electrolyte particles when a jet mill is used for pulverizing the solid electrolyte. The median diameter of the solid electrolyte particles in the graph of FIG. 3 is 143 nm.

From the results of FIGS. 2 and 3, it is apparent that a solid electrolyte having a median diameter of 150 nm or less can be prepared by the above methods of preparing the nanoscale SE.

Although a preferred embodiment of the present invention has been described above, the present invention is not limited to the above embodiment, and various modifications and improvements are possible to the extent that the object of the present invention can be achieved.

### EXPLANATION OF REFERENCE NUMERALS

2 positive electrode (positive electrode for secondary battery)

21 positive electrode active material layer

22 positive electrode current collector

23 adhesive layer

What is claimed is:

1. A positive electrode for a secondary battery, comprising:
a positive electrode current collector; and a positive electrode active material layer,
the positive electrode active material layer comprising a positive electrode active material, and
the positive electrode active material being in contact with a solid electrolyte having a median diameter of 150 nm or less.

2. The positive electrode for a secondary battery according to claim 1,
further comprising an adhesive layer formed on at least one of laminated surfaces of the positive electrode active material layer,
wherein the adhesive layer comprises the solid electrolyte having the median diameter of 150 nm or less as a main component.

3. The positive electrode for a secondary battery according to claim 1, wherein a content of the solid electrolyte having the median diameter of 150 nm or less is greater toward a laminated surface where a solid electrolyte layer is laminated in a thickness direction of the positive electrode for a secondary battery.
